(19) United States
(12) Patent Application Publication
(10) Pub. No.: US 2005/0083419 A1
(43) Pub. Date: Apr. 21, 2005

(54) Image sensing apparatus and image sensor for use in image sensing apparatus

(75) Inventors: Tsutomu Honda, Sakai-shi (JP); Hiroaki Kubo, Muko-shi (JP)

Correspondence Address: SIDLEY AUSTIN BROWN & WOOD LLP, 717 NORTH HARWOOD, SUITE 3400, DALLAS, TX, 75201, US

(73) Assignee: KONICA MINOLTA CAMERA, INC.

(21) Appl. No.: 10/793,088

(22) Filed: Mar. 4, 2004

(30) Foreign Application Priority Data
Oct. 21, 2003 (JP) 2003-361068

(51) Int. Cl. H04N 9/64; G03F 3/08

(52) U.S. Cl. 348/244; 358/529

(57) ABSTRACT

An image sensing apparatus includes: an image sensor to photoelectrically convert an object image to electrical signals; a controller to controllably read out the electrical signals generated in the image sensor; a processor to apply a predetermined image processing to the read-out electrical signals; and an estimating part to obtain a value of a dark current generated in the image sensor for estimating an internal temperature of the image sensor based on the dark current value. The image processing by the processor is altered based on the estimative value of the internal temperature of the image sensor outputted from the estimating part.

The present application is based on Japanese Patent Application No. 2003-361068 filed on Oct. 21, 2003, the contents of which are hereby incorporated by references.

### BACKGROUND OF THE INVENTION

1. Field of the Invention

The present invention relates to an image sensing apparatus, e.g., a digital camera, incorporated with an image sensor such as a CCD sensor, and more particularly to an image sensing apparatus capable of altering an image processing in an image processing section thereof, considering the temperature of the image sensor.

2. Description of the Related Art

An image sensor such as a CCD sensor for photoelectrically converting an object image to electric signals is constructed such that the electrical signals are generated based on electric charges generated by receiving light reflected from an object. In the image sensor, there is likelihood that electric charges may be generated despite the fact that light is not actually received. Such electric charges are called as a dark current. If image formation is conducted based on image data containing a dark current component, an object image containing a detection error corresponding to the dark current component may be reproduced, thereby deteriorating quality of the formed image. In view of this, conventionally, there have been proposed various techniques of eliminating an influence of a dark current.

A basic technique of eliminating an influence of a dark current is as follows. An optical black area serving as a light blocking portion is provided at a part of the image sensor. An output, i.e., a light blocking output, is obtained from the optical black area, while obtaining an output, i.e., an ordinary output, from an exposed portion of the image sensor other than the optical black area. A black level is clamped to a reference level of the light blocking output by comparing the light blocking output and the ordinary output or a like technique.

The aforementioned technique has drawbacks that a fixed pattern noise and a variation in temperature characteristics of a dark current are generated with respect to each pixel. U.S. Pat. No. 5,729,288 (hereinafter, called as D1) discloses a method for compensating an image processing signal comprising the steps of shielding an image sensor from light by closing a shutter for a time substantially equal to an exposure time to obtain dark exposure data (hereinafter, called as “dark noise data”) after acquiring image data from the image sensor, i.e., after completion of image sensing operation, and correctively calculating the acquired image data based on the dark noise data.

Further, there is proposed a technique of utilizing a phenomenon that the quantity of a noise such as a fixed pattern noise or a dark current depends on the temperature of an image sensor such as a CCD sensor. For instance, Japanese Unexamined Patent Publication No. 2000-184292 (hereinafter, called as D2) discloses an arrangement in which provided is temperature detecting means such as a temperature sensor for detecting a temperature in the vicinity of an image sensor, and an image processing signal is corrected based on an outer surface temperature of the image sensor detected by the temperature sensor in processing image data acquired from the image sensor.

In the technique disclosed in D1, it is necessary to obtain the dark noise data by closing the shutter after acquiring image data of an object by the image sensor. In this arrangement, the camera is brought to a photographing suspended state during the shutter-closing time, thereby failing to proceed with a next image sensing operation quickly. This arrangement obstructs a user from performing sequential image sensing operations, thereby impairing usability of the user.

In the technique disclosed in D2, what is detected by the temperature sensor is not the temperature of the image sensor itself but is a temperature in the vicinity on the outer surface of the image sensor. This arrangement fails to accurately calculate a dark current generated at the present moment. Specifically, even if the temperature in the vicinity on the outer surface of the image sensor including the outer surface temperature of the image sensor can be detected, this arrangement makes it impossible or difficult to estimate a correlation with the internal temperature of the image sensor because the image sensor generates heat during a sensing operation. Thereby, measurement error may be generated in measuring a dark current or a noise. Once such a measurement error occurs, a desired dark current compensation cannot be carried out even if an image processing signal is corrected, thereby failing to form an image of a desired quality.

### SUMMARY OF THE INVENTION

It is an object of the present invention to provide an image sensing apparatus capable of measuring a dark current or a noise such as a fixed pattern noise without generating a photographing suspended time, and capable of performing image processing in conformity to the operative status of an image sensor by accurately evaluating the quantity of the dark current or the noise of the image sensor and by feeding back data representing the quantity to an image processing section.

One aspect of the present invention provides an image sensing apparatus comprising: an image sensor to photoelectrically convert an object image to electrical signals; a controller to controllably read out the electrical signals generated in the image sensor; a processor to apply a predetermined image processing to the read-out electrical signals; and an estimating part to obtain a value of a dark current generated in the image sensor for estimating an internal temperature of the image sensor based on the dark current value, wherein the image processing by the processor is altered based on the estimative value of the internal temperature of the image sensor outputted from the estimating part.

These and other objects, features and advantages of the present invention will become more apparent upon reading of the following detailed description along with the accompanying drawings.

### BRIEF DESCRIPTION OF THE DRAWINGS

FIGS. 1A through 1D are illustrations each showing an external appearance of a digital camera exemplifying a first embodiment of the present invention, wherein FIG. 1A is a front view, FIG. 1B is a top plan view, FIG. 1C is a side view, and FIG. 1D is a rear view of the digital camera.

FIG. 2 is a cross-sectional view showing a schematic construction of the digital camera.

FIG. 3 is a block diagram for explaining photographing processing by the digital camera.

FIG. 4 is a functional block diagram for explaining an operation of essential parts of the digital camera.

FIG. 5 is a block diagram showing a schematic arrangement of an image sensor used in the first embodiment of the present invention.

FIG. 6 is an illustration showing an exemplified method as to how signal charges are read out from the image sensor.

FIG. 7 is a plan view schematically showing the image sensor.

FIGS. 8A and 8B are timing charts for explaining charge accumulation operations of the digital camera.

FIG. 9 is a flowchart for explaining processing by the digital camera.

FIGS. 10A through 10C are graphs showing statuses as to how signals are read out from the image sensor.

FIG. 11 is a graph showing a relation between a charge accumulation time and a dark current value detected in the image sensor in terms of temperature.

FIG. 12 is a graph showing examples that plural dark current data are plotted out to establish characteristics curves in the graph shown in FIG. 11.

FIG. 13 is a plan view showing a schematic arrangement of an image sensor used in a second embodiment of the present invention.

FIGS. 14A and 14B are timing charts for explaining charge accumulation operations in a digital camera according to the second embodiment of the present invention.

FIG. 15 is a graph showing an exemplified relation between a temperature and a saturation voltage of the image sensor.

FIG. 16 is a functional block diagram showing an example of noise reduction control in Use Example 2 of the present invention.

### DETAILED DESCRIPTION OF THE PREFERRED EMBODIMENTS

Preferred embodiments of an image sensing apparatus according to the present invention are described referring to the accompanying drawings.

(First Embodiment)

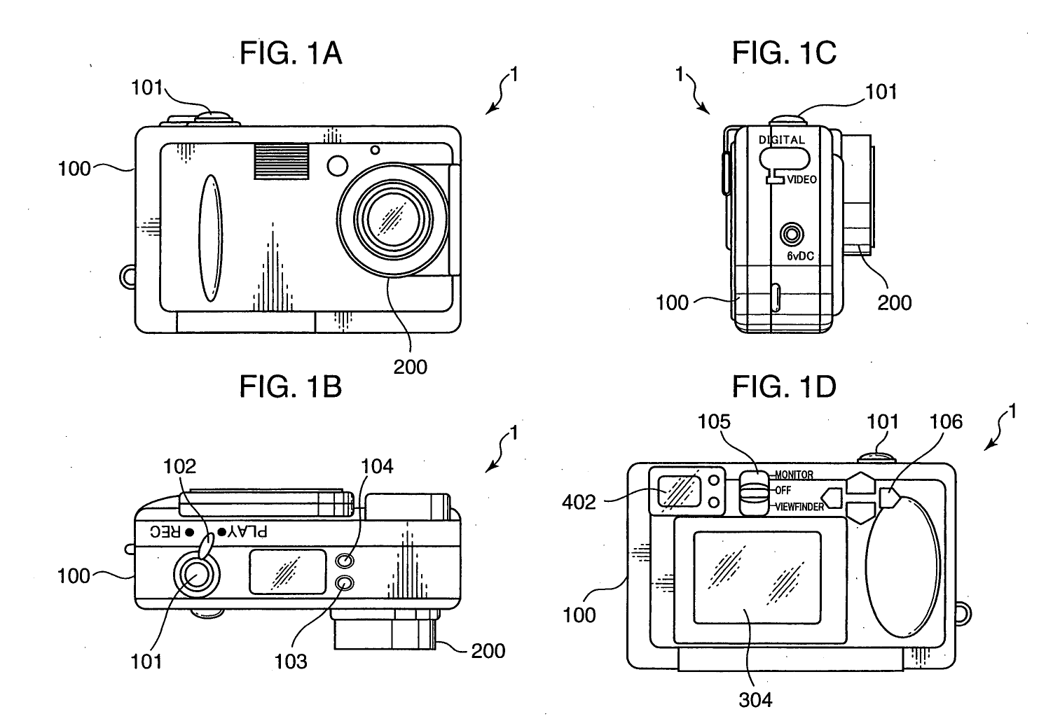

FIGS. 1A through 1D are illustrations each showing an external appearance of a digital camera 1 using a single image sensor as a first embodiment of the present invention. FIGS. 1A, 1B, 1C, and 1D are a front view, top plan view, side view, and rear view of the digital camera 1, respectively. In these drawings, a main body 100 of the camera 1 is provided with a taking lens 200 on the front surface thereof. The camera body 100 is further formed with an electronic viewfinder window 402 in an upper part on the rear surface thereof, and a display monitor 304 such as an LCD below the electronic viewfinder window 402. The electronic viewfinder window 402 and the display monitor 304 are adapted to reproduce and display an image recorded in an internal recording medium while the camera 1 is in the reproduction mode, i.e., PLAY mode, and to display an electronic video image, i.e., so-called “live-view image,” of an object which is captured during a photographing stand-by state while the camera 1 is in a recording mode, i.e., REC mode. It is possible to selectively display these images through the electronic viewfinder window 402 or on the display monitor 304 in response to a user's manipulation.

The camera body 100 is further provided, on the upper surface thereof, with a shutter start button 101 (referred to as “shutter button” hereinafter) for allowing a user to designate a photographing operation, a photographing mode changeover switch 102 for allowing the user to switch over the mode between the reproduction mode, i.e., PLAY mode, and the recording mode, i.e., REC mode, a monitor enlargement switch 103 for allowing the user to enlargedly display an electronic image through the electronic viewfinder window 402 and on the display monitor 304. The camera body 100 is further provided with a mode selecting switch 104 for allowing the user to designate the photographing mode of the camera 1 between an ordinary photographing mode and an adaptive photographing mode, which will be described later. When the adaptive photographing mode is set, an optimal image processing is implemented by monitoring the temperature of an image sensor such as a CCD sensor in an estimative manner.

The camera body 100 is further provided, on the rear surface thereof, with a main switch 105 in the form of a slide switch. By sliding the main switch 105 to a predetermined position, power of the camera 1 is turned on and off, and active display is selectively changed over between the electronic viewfinder window 402 and the display monitor 304. The camera body 100 is further provided, on the right side of the main switch 105 in FIG. 1D, with a group of push switches 106 serving as a switch unit for feeding recorded images, frame by frame, in the reproduction mode, and a zoom switch for the taking lens 200.

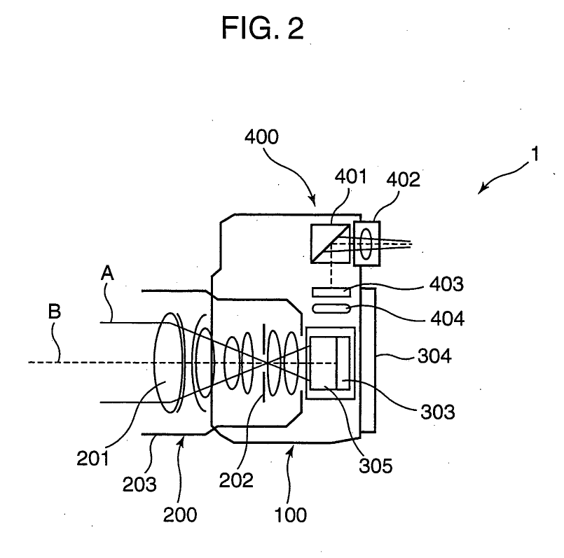

FIG. 2 is a cross-sectional view showing a schematic arrangement of the digital camera 1. The camera 1 basically includes the boxy camera body 100, the taking lens 200 mounted on the camera body 100, and an electronic viewfinder unit 400 mounted on the upper part of the camera body 100.

The taking lens 200 is adapted to pass reflected light, i.e., incident light, from an object disposed under an unillustrated light source onto an imaging plane of an image sensor 303 in the camera body 100. The taking lens 200 is fixed to the front surface of the camera body 100. The taking lens 200 includes a photographing optical system 201 comprised of a group of lenses, and an optical diaphragm 202 disposed in the photographing optical system 201 for regulating an incident light amount. The photographing optical system 201 and the optical diaphragm 202 are held at respective predetermined positions in a lens barrel 203.

Specifically, the camera 1 is so configured as to photoelectrically convert an object light image incident through the taking lens 200 to image signals with photoelectric conversion elements to implement a predetermined signal processing to the image signals, to record the processed image signals in a recording medium such as an image memory or a memory card, and to reproduce a recorded image. As mentioned above, the display monitor 304 such as an LCD is arranged on the rear surface of the camera body 100.

The image sensor 303, i.e., a group of photoelectric conversion elements, such as a CCD area sensor is disposed on the optical axis B of the taking lens 200 at an inner position near the rear surface of the camera body 100. The image sensor 303 is, for example, an area sensor equipped with a transmission filter arrayed with patches of three primary colors of red (R), green (G), and blue (B) in a checkered pattern in the unit of pixels. The image sensor 303 may employ a progressive-scan type CCD sensor based on the interline transfer system. An interlaced-scan type CCD sensor may also be used when using a mechanical shutter. Further, an optical low-pass filter 305 of a certain thickness is arranged in front of the image sensor 303 to remove moire fringe on the image sensor 303.

The image sensor 303 includes an optical black area serving as a light blocking portion. The optical black area is formed on a periphery of the imaging area of the image sensor 303 to fix or clamp the black level. The optical black area will be described later in detail.

The electronic viewfinder 400 is adapted for a user to confirm an image to be actually photographed through an eyepiece portion thereof by guiding an object light image to the eyepiece portion. The electronic viewfinder 400 includes a prism 401, the electronic viewfinder window 402 serving as the eyepiece portion for allowing a user to confirm a formed object image, a light-transmissive compact liquid crystal display monitor (hereinafter, called as “LCD monitor”) 403 disposed below the prism 401, and a light source 404 for illuminating the LCD monitor 403. The LCD monitor 403 is adapted to display a picked-up live-view image. The prism 401 is so configured as to reflect an image displayed on the LCD monitor 403 and to guide the reflected image to the electronic viewfinder window 402.

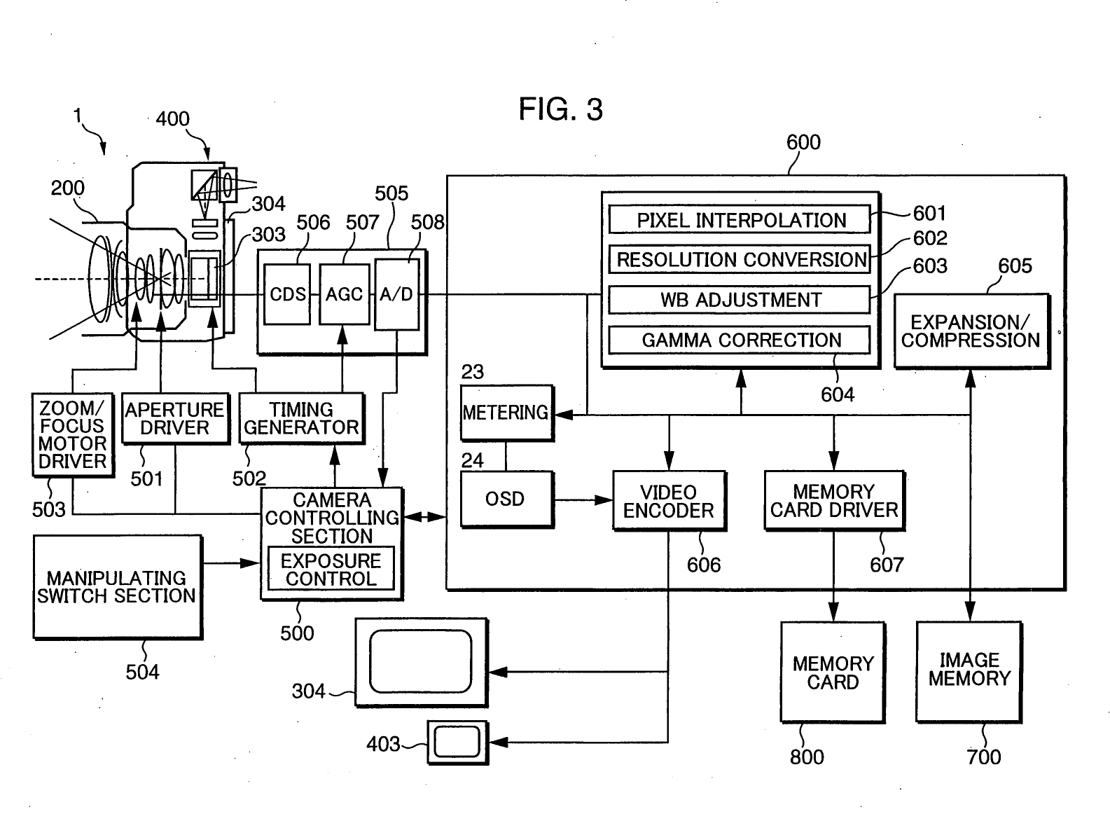

FIG. 3 is a block diagram showing image sensing processing performed by the digital camera 1 having the above construction. Elements in FIG. 3 identical or similar to those in FIGS. 1A through 2 are denoted at the same reference numerals. In FIG. 3, a camera controlling section 500 centrally controls photographing operation of the digital camera 1. As will be described later in detail, the camera controlling section 500 is adapted to control an aperture driver 501, a timing generator 502, and a zoom/focus motor driver 503 to perform photographing operation, control an analog signal processing section 505 and a digital image processing section 600 to implement a predetermined image processing with respect to a photographed image and to record the photographed image in a memory card 800, and control the display monitor 304 and the LCD monitor 403 to display the recorded image thereon.

The camera controlling section 500 extracts image signals derived from a light metering area which is defined at a predetermined position on the image sensor 303, from image signals picked up in the image sensor 303 during a photographing stand-by state while the camera 1 is set to an electronic viewfinder mode, calculates an exposure control value for photographing with use of the extracted image signal, and sets an aperture value of the optical diaphragm 202 and a charge accumulation time, i.e., exposure time corresponding to a shutter speed, of the image sensor 303 based on the calculation result and a predetermined program chart.

The aperture driver 501 is adapted to control driving of the optical diaphragm 202 in the taking lens 200. The aperture driver 501 sets the opening amount of the optical diaphragm 202 to a predetermined value based on the aperture value outputted from the camera controlling section 500.

The timing generator 502 is adapted to control image sensing operation of the image sensor 303 such as charge accumulation caused by exposure and read-out of accumulated charges. The timing generator 502 generates a predetermined timing pulse such as a vertical transfer pulse, a horizontal transfer pulse, and a charge sweep pulse for outputting these pulses to the image sensor 303 based on a photographing control signal from the camera controlling section 500. While the camera 1 is set to a live-viewable state, i.e., live-view mode, or the electronic viewfinder mode, the timing generator 502 enables the image sensor 303 to pick up frame images at an interval of e.g., every 1/30 second, and output the picked up frame images sequentially to the analog signal processing section 505.

Electric charges are accumulated in association with an exposure operation of the image sensor 303 during exposure for photographing. In other words, an object light image is photoelectrically converted to image signals. The accumulated charges are outputted to the analog signal processing section 505. After the analog signal processing section 505 and the digital image processing section 600 implement a predetermined image processing with respect to each frame image during a photographing stand-by state, the processed image is displayed on the LCD monitor 403 if the camera 1 is set to the electronic viewfinder mode. Further, at the time of photographing, a photographed image is recorded in the memory card 800 after the analog signal processing section 505 and the digital image processing section 600 implement a predetermined image processing with respect to the photographed image.

The zoom/focus motor driver 503 is adapted to control zooming for adjusting a focal length of the photographing optical system 201 in the taking lens 200, and to control focusing for adjusting a focusing state of a focus lens in the taking lens 200. The zoom/focus motor driver 503 controls driving of the zoom/focus motor based on a signal indicative of a focal length and a signal indicative of a focusing state outputted from the camera controlling section 500.

A camera manipulating switch section 504 is provided to allow a user to operate various buttons provided on the camera body 100 and to transmit the operation information of the buttons into the camera controlling section 500. The camera manipulating switch section 504 includes a main switch corresponding to a power switch, a switch corresponding to the shutter button 101, and a switch corresponding to the photographing mode changeover switch 102.

The analog signal processing section 505 is adapted to implement a predetermined signal processing to image signals outputted from the image sensor 303, namely, analog signals indicative of light amounts received by respective pixels of the CCD area sensor, and then to convert the analog signals to digital signals for outputting to the camera controlling section 500. The analog signal processing section 505 includes a correlation double sampling (CDS) circuit 506, an automatic gain control (AGC) circuit 507, and an analog to digital (A/D) converter circuit 508. The CDS circuit 506 is adapted to reduce a reset noise component in the analog image signals. The AGC circuit 507 is adapted to correct the level of the analog image signals to an appropriate level. The A/D converter circuit 508 is adapted to convert the analog image signals to the digital image signals of 10 bit for each pixel, for instance. Hereinafter, the digital image signals are referred to as “image data”. The analog signal processing section 505 is sometimes called as an analog front end (AFE), and generally consists of one integrated circuit.

The digital image processing section 600 implements various signal processing with respect to image data outputted from the analog signal processing section 505, such as pixel data interpolation, image resolution conversion, white balance adjustment, gamma correction, and image data compression/expansion to generate an image file. Also, the digital image processing section 600 controllably reproduces and displays an image on the display monitor 304 after the signal processing, or records the digital image in the memory card 800. Image data outputted to the digital image processing section 600 is temporarily written in the image memory 700 in synchronism with reading out of the image signals from the image sensor 303. Thereafter, respective blocks in the digital image processing section 600 implement their individual processing by reading out and writing back the image data stored in the image memory 700 according to needs.

The digital image processing section 600 includes a pixel data interpolation circuit 601, an image resolution conversion circuit 602, a white balance adjustment circuit 603, a gamma correction circuit 604, an image compression/expansion circuit 605, a video encoder 606, and a memory card driver 607.

The pixel data interpolation circuit 601 is adapted to interpolate pixel data which do not actually exist in a frame image with respect to each color component of R, G, B. Specifically, in this embodiment, since the image sensor 303 has a single CCD area sensor in which pixels corresponding to the color components of R, G, B are arrayed in a checkered pattern, a frame image with respect to each color component of R, G, B is constituted of plural data (hereinafter, each called as “pixel data”) obtained from discretely positioned pixels. The pixel data interpolation circuit 601 interpolates pixel data which does not exist in the frame image with use of the existing plural pixel data.

Image data of each color component of R, G, B which are outputted from the analog signal processing circuit 505 and stored in the image memory 700 are outputted to the pixel data interpolation circuit 601 to interpolate pixel data. Regarding a frame image of the color component G, which has a higher spatial frequency band due to arrangement of G-pixels, the pixel data interpolation circuit 601 implements masking of image data constituting the frame image with a predetermined filter pattern, calculates a mean value of pixel data after, with use of a median filter, removing a maximal value and a minimal value of the pixel data among the existing pixel data near the pixel whose data is required to be interpolated, and sets the mean value as the pixel data to be interpolated. Regarding pixels of frame images of the color components R and B, the pixel data interpolation circuit 601 implements masking of image data constituting the frame image of the corresponding color with a predetermined filter pattern, calculates a mean value of the existing pixel data near the pixel whose data is required to be interpolated, and sets the mean value as the pixel data to be interpolated. The frame image data of the respective color components after the pixel data interpolation are stored in the image memory 700.

The image resolution converting circuit 602 is adapted to convert the image resolution of an image to be recorded to a predetermined number of pixels. Specifically, the image resolution conversion circuit 602 sets the image resolution to a predetermined number of pixels by implementing horizontal or vertical compression, or reading out the pixel data every predetermined number of pixels, i.e., performing skipping of pixel data, with respect to the image data after the pixel data interpolation. In case of generating an image to be displayed on the display monitor 304 or through the electronic viewfinder window 402 of the electronic viewfinder 400, the image resolution conversion circuit 602 reads out the pixel data arrayed in horizontal and vertical directions every predetermined number of pixels to generate an image of a low resolution for displaying on the LCD display monitor 304 or through the electronic viewfinder window 402.

The white balance adjustment circuit 603 is adapted to adjust white balance (WB) of the digital image after the pixel data interpolation. The white balance adjustment circuit 603 reads out image data of each color component of R, G, B from the image memory 700, and corrects the level of the respective image data based on WB adjustment data which has been set in advance by the camera controlling section 500. Specifically, the white balance adjustment circuit 603 determines a portion of a photographed object image that is supposed to be originally of white color based on brightness data, saturation data or the like, calculates a mean value of each color component of R, G, B at the presumably white color portion, as well as the ratio of G to R and the ratio of G to B, and implements the level correction by use of the G/R ratio and the G/B ratio as correction gains for R and B components, respectively. The respective image data of the color components of R, G, B after the level correction are stored in the image memory 700.

The gamma correction circuit 604 is adapted to correct gradation characteristics of the image data after the WB adjustment to gradation characteristics of image data to be displayed on the display monitor 304 or to be externally outputted to be displayed on an external television monitor, for example. The gamma correction circuit 604 non-linearly converts the level of the image data read out from the image memory 700 with respect to each color component of R, G, B with use of predetermined gamma characteristics, and implements offset adjustment. The image data of the respective color components after the conversion and the offset adjustment are stored in the image memory 700.

The image compression/expansion circuit 605 compresses image data constituting a sensed image to be recorded in the memory card 800, and expands the compressed image data constituting the sensed image which is read out from the memory card 800 for reproduction and display on the display monitor 304 or the LCD monitor 403 of the electronic viewfinder 400. The data representing the sensed image is compressed when being recorded into the memory card 800 to secure a large recordable capacity of the memory card 800 by reducing the size of the data.

The video encoder 606 converts image data to be displayed on the display monitor 304 or the LCD monitor 403 to an image signal in conformity with the NTSC system or the PAL system because the display monitor 304 and the LCD monitor 403 are driven based on a video signal in conformity with the NTSC system or the PAL system. The video encoder 606 outputs the converted image signal to the display monitor 304 or the LCD monitor 403.

The image memory 700 is a memory for temporarily storing image data to enable predetermined digital image processing to be performed to the image data. The image memory 700 has a storage capacity capable of storing data of at least 3 frames of images, and thereby, stores sensed images of color components R, G and B independently. The memory card 800 is a memory for storing image data in a compressed state. The memory card 800 storing the image data can be replaced with new one to serve as an external memory for the stored image data.

In the above arrangement, in a pre-viewable state or a preview mode while the camera 1 is set to the recording mode, each frame image, e.g., image of a low resolution of 640 pixels×240 pixels, stored in the image memory 700 after the gamma correction is read out to the video encoder 606, converted to image signals in conformity with the NTSC system or the PAL system, and outputted to the display monitor 304 or the LCD monitor 403 as a field image.

In recording a sensed image, image data of the sensed image after the gamma correction is read out from the image memory 700, and compressed to an image resolution suitable for recording according to, e.g., the JPEG system. The image resolution is set by the image compression/expansion circuit 605. The compressed image data is recorded in the memory card 800 by way of the memory card driver 607. In recording the compressed image data in the memory card 800, it is desirable to create a screen-nail image, which is a VGA image, i.e., a graphics image of 640 pixels×480 pixels, for reproduction and display by linking the screen-nail image to the compressed image data of the predetermined resolution, and to record the screen-nail image in the memory card 800 as well as the compressed image data.

Further, in reproducing the sensed image, the sensed image of a compressed form recorded in the memory card 800 is outputted to the image compression/expansion circuit 605 by way of the memory card driver 607. After de-compressing, i.e., expanding the compressed image data into image data of the original size, the de-compressed data is converted into an image signal according to the NTSC system or the PAL system for outputting to the display monitor 304 or the compact LCD monitor 403. In this case, it is preferable to display the screen-nail image, i.e., VGA image, on the display monitor 304 or the compact LCD monitor 403 because such an arrangement provides a relatively high-speed image reproduction and display.

While the digital camera 1 according to the first embodiment is basically constructed as mentioned above, the digital camera has further features that a dark current of the image sensor 303 such as a CCD sensor is detected, an internal temperature of the image sensor 303 is estimated based on the dark current value, and image processing in the respective blocks of the image processing section, i.e., the analog signal processing section 505 and the digital image processing section 600, can be altered depending on the estimated temperature of the image sensor 303. In the following, the features will be described.

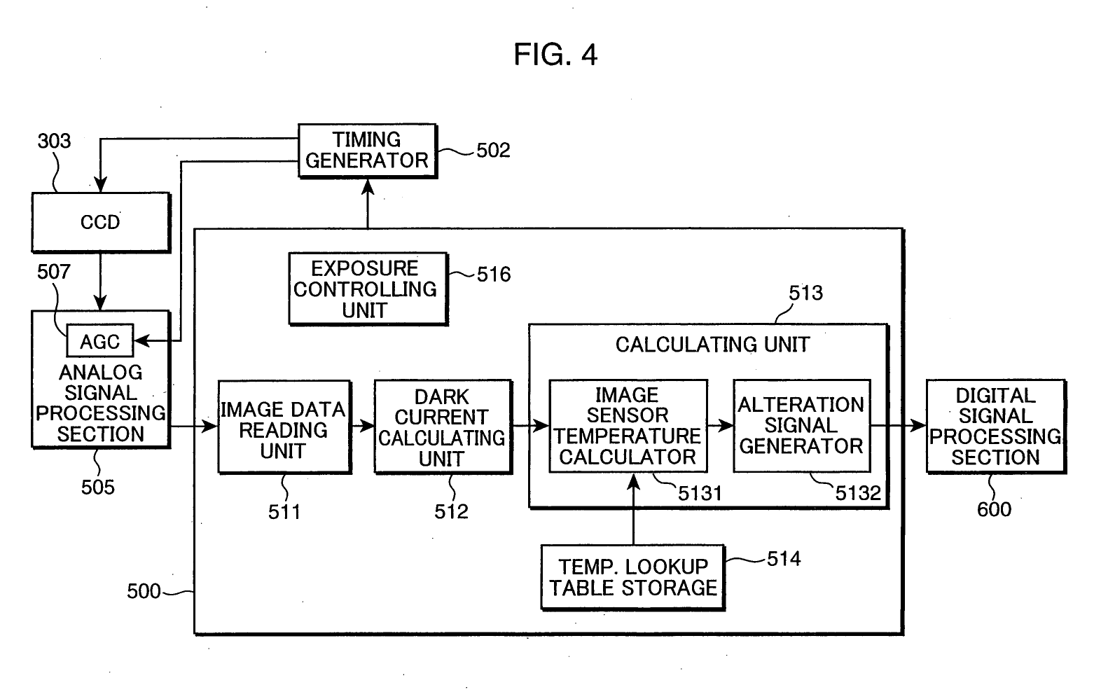

FIG. 4 is a functional block diagram for explaining operations of essential parts of the digital camera 1 to perform estimation of the temperature of the image sensor 303 and alteration of an image processing signal. The essential parts of the digital camera 1 include the image sensor 303, the camera controlling section 500, and peripheral parts thereof.

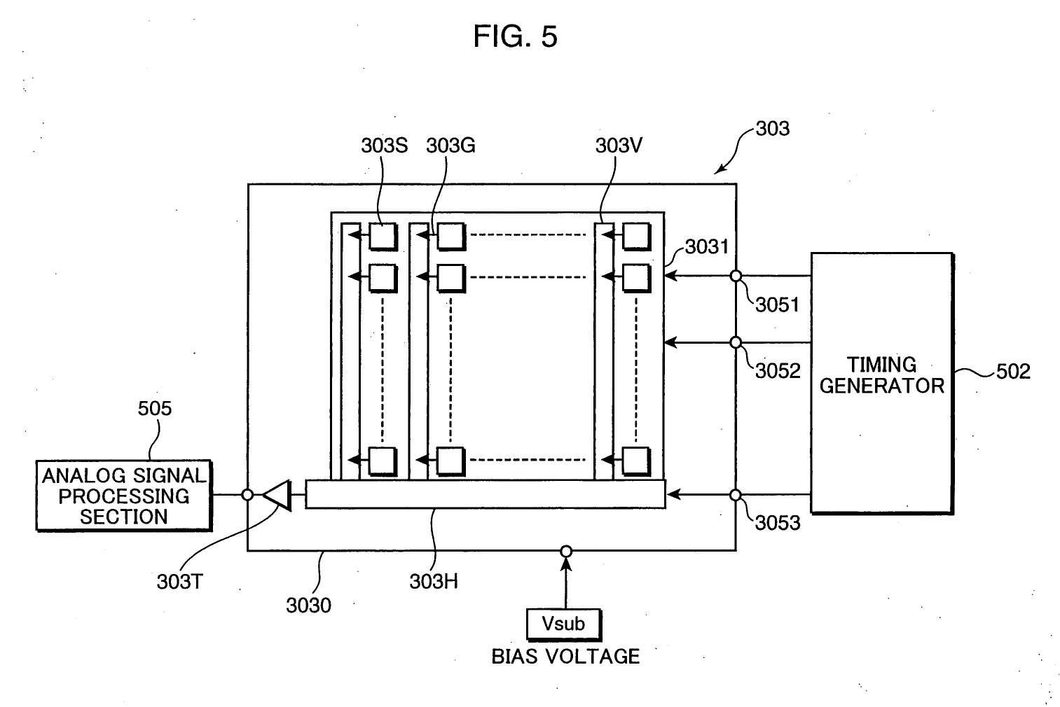

As mentioned above, the image sensor 303 is a CCD area sensor according to the interline transfer system. The configuration of a typical CCD sensor will be described referring to FIG. 5. An imaging area 3031 is provided on a semiconductor substrate 3030 of the CCD sensor, i.e., the image sensor 303. The imaging area 3031 includes a number of sensing elements 303S, which are arrayed in a matrix and each converts incident light to a signal charge of a quantity corresponding to the received light amount and accumulates the signal charge, read-out gate units 303G each serving as a gate for reading out the accumulated signal charge from the corresponding sensing element 303S, and arrays of vertical transfer units, i.e., vertical CCDs, 303V each of which is arranged per column of the sensing elements 303S and transfers the signal charge read out from the corresponding column of the sensing elements 303S to a horizontal transfer unit, i.e., horizontal CCD, 303H. The horizontal transfer unit 303H is provided below the vertical transfer units 303V. The signal charges corresponding to each column of the sensing elements 303S are transferred from the corresponding vertical transfer unit 303V to the horizontal transfer unit 303H sequentially.

The image sensor 303 has a vertical overflow drain structure. The semiconductor substrate 3030 includes an overflow drain terminal 3051, a vertical transfer pulse input terminal 3052, and a horizontal transfer pulse input terminal 3053. The timing generator 502 supplies a charge sweep pulse to the overflow drain terminal 3051, and enables the sensing elements 303S to sweep out excessive signal charges that have been accumulated in the sensing elements 303S. Also, the timing generator 502 supplies a charge read-out pulse to the read-out gate units 303G to enable the read-out gate units 303G to transfer the accumulated signal charges to the corresponding vertical transmission unit 303V.

The timing generator 502, for example, supplies 4-phase vertical transfer pulses, i.e., φV1, φV2, φV3, φV4 to the vertical transfer pulse input terminal 3052 to transfer the signal charges that have been transferred from the corresponding column of the sensing elements 303S to the corresponding vertical transfer unit 303V, to the horizontal transfer unit 303H. The timing generator 502 also supplies two-phase horizontal transfer pulses, i.e., φH1, φH2 to the horizontal transfer pulse input terminal 3053 to transfer the signal charges transferred to the horizontal transfer unit 303H to a charge to a voltage converter 303T provided at a leading end of the horizontal transfer unit 303H in the charge transfer direction by way of the horizontal transfer unit 303H. In this way, the signal charges that have been transferred to the horizontal transfer unit 303H are converted to voltage signals sequentially by the charge to voltage converter 303T, and outputted to the analog signal processing section 505. A bias voltage Vsub is suppliable to the semiconductor substrate 3030 in such a manner that a saturation signal charge amount of the sensing element 303S is determined based on a value of the bias voltage Vsub.

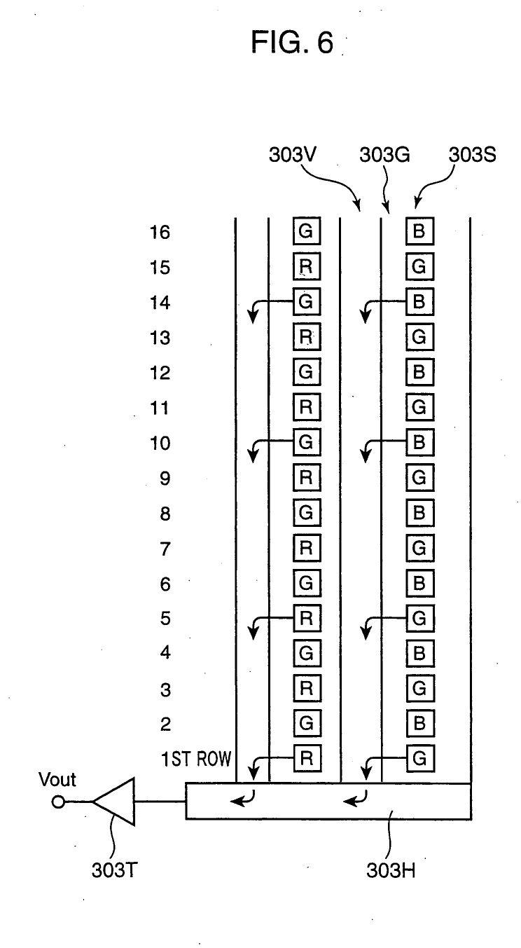

FIG. 6 is an illustration showing an exemplified method as to how signal charges are read out from the image sensor 303. According to this read-out method, 16 pixels corresponding to a column of the image sensing elements 303S are set as a unit, and signal charges from 4 pixels among the 16 pixels are read out by the corresponding vertical transfer unit 303V at one time. Specifically, signal charges are read out from 4 pixels in the 16 pixels by the corresponding vertical transfer unit 303V by skipping 12 pixels, and outputted to the horizontal transfer unit 303H during a horizontal blanking period. The signal charges corresponding to two rows, e.g., the first and fifth rows, of each column of the vertical transfer units 303V are mixed up in the horizontal transfer unit 303H, and are transferred to the charge voltage converter 303T. The read-out method of reading out signal charges from 4 pixels in the unit of 16 pixels by the vertical transfer unit 303V by skipping 12 pixels and of mixing up signal charges corresponding to two rows of the vertical transfer units 303V by the horizontal transfer unit 303H secures the signal charge read-out speed 8 times as high as a frame read-out method, which reads out signal charges from all the pixels in a frame image. The method of reading out signal charges, however, is not specifically limited to the embodiment of the present invention. The frame read-out method, and a method of reading out signal charges at a speed twice as high as the frame read-out method by reading out signal charges from 2 pixels in 4 pixels are also applicable.

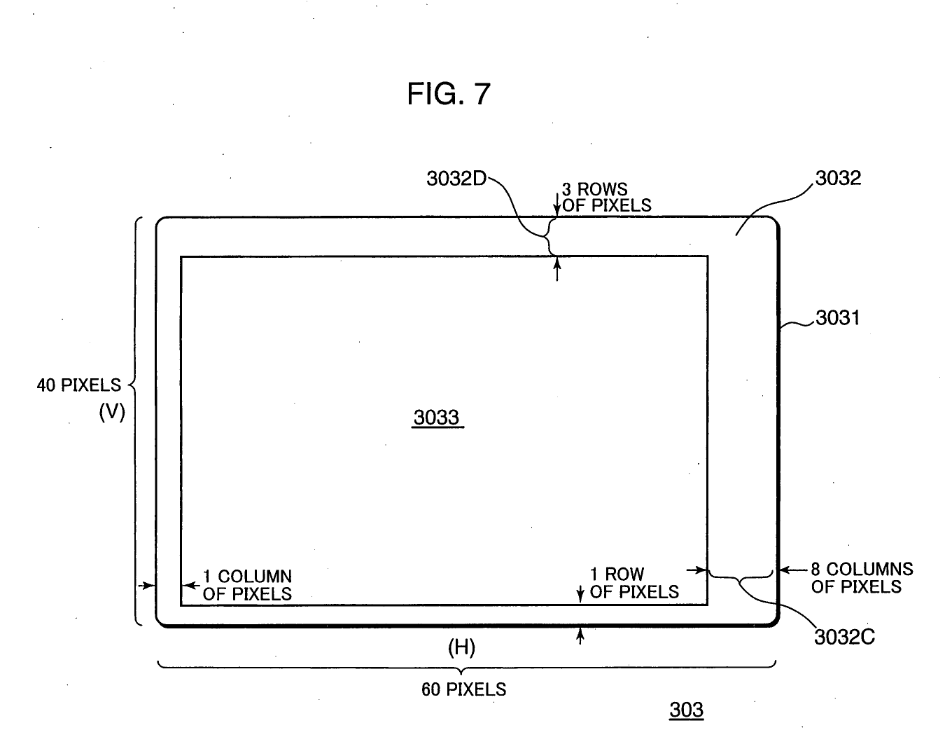

In this embodiment, as shown in FIG. 7, the image sensor 303 is provided with an optical black area 3032 serving as a light blocking portion on a periphery of the imaging area 3031 by masking. 2400 pixels in total, namely, 60 pixels in horizontal direction and 40 pixels in vertical direction are arrayed in the imaging area 3031. An actual digital camera usually employs an image sensor having several million pixels. However, in this embodiment, the image sensor of a small number of pixels is illustrated for the sake of explanation. The optical black area 3032 covers an area corresponding to a leftmost 1 column of pixels, rightmost 8 columns of pixels, uppermost 3 rows of pixels, and a lowermost 1 row of pixels. The imaging area 3031 except for the optical black area 3032 constitutes an effective pixel area 3033.

The optical black area 3032 is adapted to clamp the black level to a reference value of a light blocking output. In this embodiment, the rightmost 8 columns of pixels in the optical black area 3032 function as a clamping area 3032C for clamping the black level to the reference value. In this arrangement, it is possible to read out signal charges from the clamping area 3032C. Since the optical black area 3032 is blocked from light, signal charges from the pixels corresponding to the optical black area 3032 are not accumulated, and naturally, a signal current representing image data should not be detected. However, as mentioned above, there is a case that a dark current is generated, and the temperature of the CCD sensor, i.e., image sensor 303, is presumable based on the dark current. Accordingly, in this embodiment, the digital camera 1 is so configured that signal charges are readable also from an upper optical black area 3032D corresponding to the uppermost 3 rows of pixels in the optical black area 3032.

Referring back to FIG. 4, the camera controlling section 500 includes an image data reading unit 511 for reading out image data that has been photoelectrically converted by the image sensor 303 and digitized by the analog signal processing section 505, and for reading out a signal indicative of a dark current generated in the image sensor 303. The camera controlling section 500 further includes a dark current calculating unit 512 for calculating an actually generated dark current value (or absolute value) based on the dark current signal read out from the image data reading unit 511, a temperature lookup table storage 514 storing a temperature lookup table showing a relation between the dark current value and the temperature of the image sensor 303, and a calculating unit 513 having an image sensor temperature calculator 5131 for outputting an estimative value of the internal temperature of the image sensor 303 based on the temperature lookup table and the dark current value calculated by the dark current calculating unit 512, and an alteration signal generator 5132 for generating various correction image processing signals based on the estimative temperature of the image sensor 303 to output the correction image processing signals to the digital image processing section 600.

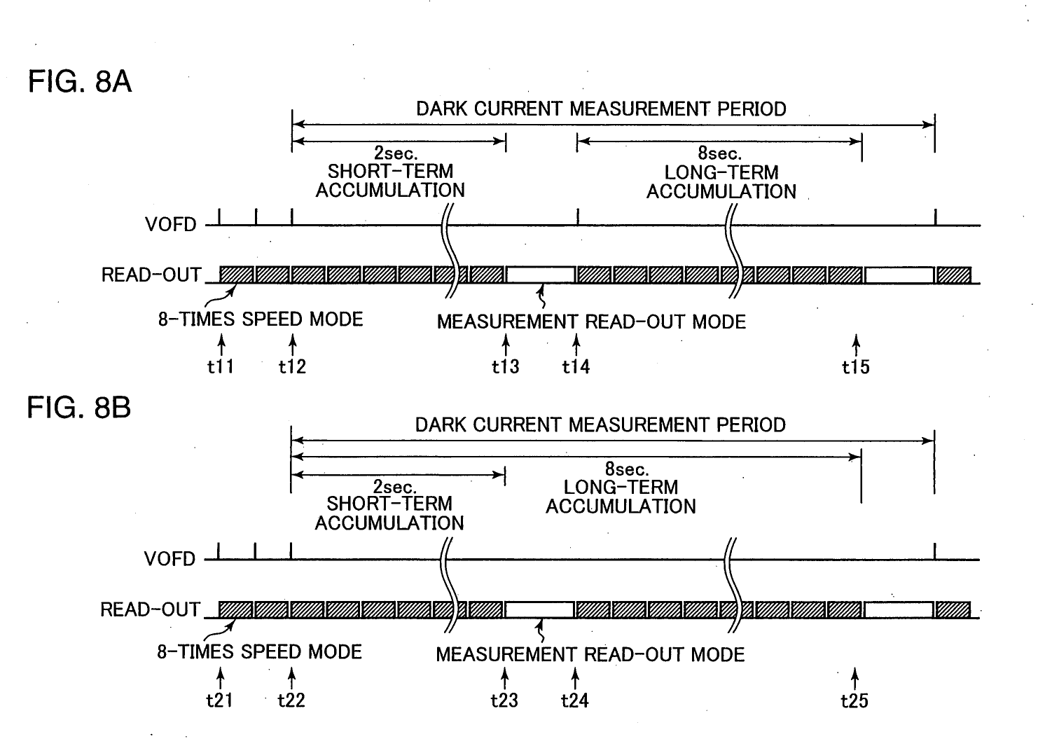

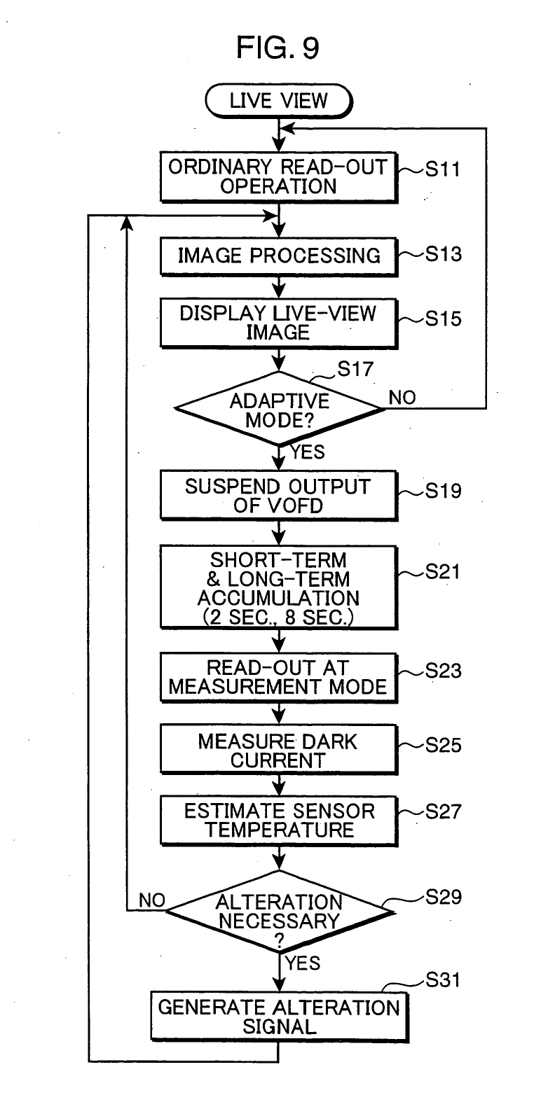

Operations of the digital camera 1 for detecting the temperature of the image sensor 303 are described referring to the timing chart in FIG. 8A and the flowchart in FIG. 9. First, when the main switch 105 is turned on, and the camera is set to the REC mode by manipulation of the photographing mode changeover switch 102, a live-view routine starts, as shown in FIG. 9. Specifically, a charge sweep pulse is supplied to the overflow drain terminal 3051 of the image sensor 303 at a predetermined timing, e.g., a cycle of 1/30 sec., to sweep the excessively accumulated signal charges in the sensing elements 303S, and a charge read-out pulse is supplied to the corresponding read-out gate units 303G to transfer the signal charges to the vertical transfer units 303V.

Upon receiving the signal charges, the vertical transfer units 303V transfer the signal charges to the horizontal transfer unit 303H as timed with supply of a vertical transfer pulse to the vertical transfer pulse input terminal 3052. Upon receiving the signal charges from the vertical transfer unit 303V, the horizontal transfer unit 303H transfers the signal charges to the charge voltage converter 303T as timed with supply of a horizontal transfer pulse to the horizontal transfer pulse input terminal 3053. In this fashion, an ordinary read out of the signal charges is implemented (Step S11). Specifically, in the timing chart of FIG. 8A, sweep out of excessively accumulated charges from the sensing elements 303S, and read out of the signal charges at e.g., 8-times speed (FIG. 6) are executed as timed with an output of a charge sweep pulse (hereinafter, simply referred to as “VOFD”) from the timing t11 of initiating the live-view mode. As timed with the sweep out of the excessively accumulated signal charges, a next accumulation of charges is started.

Analog image signals which have been read out and converted to analog signals by the charge to the voltage converter 303T are applied with an image processing in the digital image signal processing section 600 after being converted to digital image signals, i.e., image data, by the analog signal processing section 505 (Step S13). Image data after the image processing is temporarily stored in the image memory 700, read out by the video encoder 606, and displayed as a live-view image on the display monitor 304 or the LCD monitor 403 (Step S15).

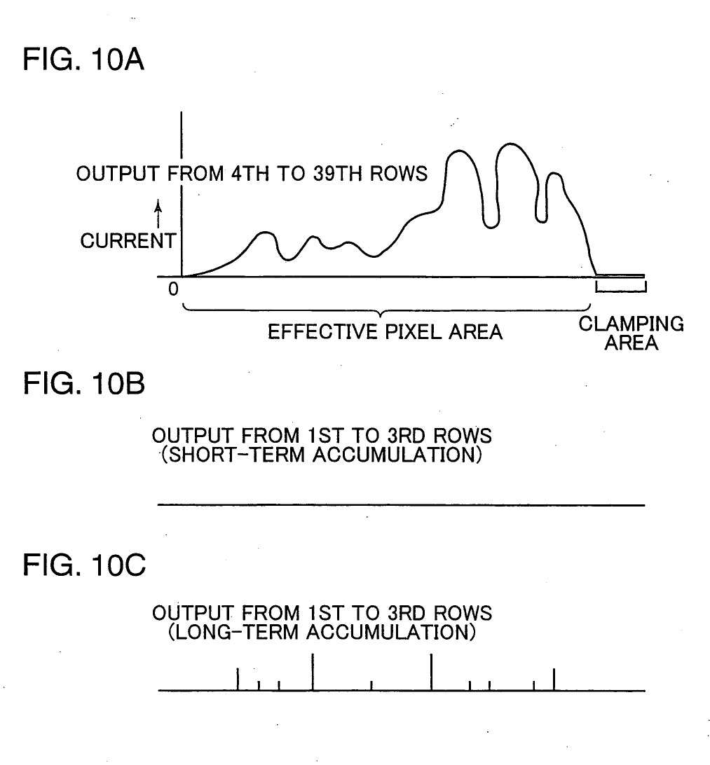

The read-out operation is implemented in the effective pixel area 3033 and the clamping area 3032C, namely, in this embodiment, the region corresponding to pixels from the 4-th to 39-th lines in vertical direction. FIG. 10A is a graph showing an example of outputted analog image signals corresponding to pixels from the 4-th to 39-th lines after level correction in the AGC circuit 507 of the analog signal processing section 505. As shown in FIG. 10A, analog signals that have been sensed in the effective pixel area 3033, namely, signal charges accumulated in the effective pixel area 3033 are outputted, whereas the signal output in the clamping area 3032C of the optical black area 3032 is null because the optical black area 3032 is blocked from light.

After Step S15, the mode selecting switch 104 of the camera body 100 is turned on, and it is judged whether the adaptive photographing mode has been designated (Step S17). If it is judged that the adaptive photographing mode is not designated (NO in Step S17), the routine returns to Step S11 to cyclically repeat the operations from Step S11 to Step S15. On the other hand, if it is judged that the adaptive photographing mode is designated (YES in Step S17) at the timing t12 in FIG. 8A, supply of a charge sweep pulse (VOFD) to the overflow drain terminal 3051 is suspended (Step S19), and a first signal charge accumulation for measuring a dark current in the sensing elements 303S of the image sensor 303 is initiated (Step S21). Specifically, during the first signal charge accumulation time, discharge of signal charges from the upper optical black area 3032D corresponding to the uppermost 3 rows of pixels in the optical black area 3032 is suspended, and a dark current is kept on being accumulated if such a dark current is generated. Read-out operation in the skipping manner for the live-view display is executed even during the first signal charge accumulation time (see FIG. 8A).

Charge accumulation method for measuring a dark current is not specifically limited. However, the longer the charge accumulation time is, the easier a dark current detection is. Therefore, it is desirable to set the charge accumulation time for dark current measurement at least 1 second. This is because a charge accumulation time shorter than 1 second may obstruct acquiring dark current data, thereby lowering precision in estimation of the temperature of the image sensor 303. On the other hand, an excessively long charge accumulation time may fail to conduct a temperature estimation because a user may wish to proceed with next photographing during such a long charge accumulation time. In view of this, it is desirable to set the charge accumulation time not longer than about 10 to 15 seconds.

It is sufficient to implement the charge accumulation once per dark current measurement. However, it is preferable to implement the charge accumulation plural number of times by differentiating the charge accumulation times from each other in order to enhance precision in the temperature estimation. For instance, implementing charge accumulation twice, in which a relatively short-term accumulation is conducted once, and a relatively long-term accumulation is conducted once is effective in estimating the temperature of the image sensor more accurately, because the number of data compared with the temperature lookup table stored in the temperature lookup table storage 514, which will be described later, is increased. Further, a noise component other than the dark current can be detected substantially without a significant difference between the short-term accumulation and the long-term accumulation in the combined charge accumulations. On the other hand, the rising rate of a dark current component is larger in the long-term accumulation than in the short-term accumulation. An accurate dark current detection can, therefore, be implemented by comparing the short-term accumulation and the long-term accumulation. Thus, a precise temperature estimation can be executed with respect to the image sensor 303.

In view of the above, in this embodiment, combination of a short-term accumulation and a long-term accumulation is adopted. The short-term accumulation is conducted for 2 seconds. During the short-term accumulation, charge sweep operation from the sensing elements 303S with use of the overflow drain terminal 3051 is suspended. Further, the long-term accumulation is conducted for 8 seconds. Similarly to the short-term accumulation, during the long-term accumulation, charge sweep operation from the sensing elements 303S with use of the overflow drain terminal 3051 is suspended. Such an arrangement may make it difficult to control the electronic shutter of the camera for displaying a live-view image. However, as far as the electronic shutter is not operated at a high speed, excessive charges can be discharged by way of the vertical transfer path. If the electronic shutter is operated at a high speed, excessive charges may be handled by gain adjustment, closing of the diaphragm, or the like.

The short-term accumulation and the long-term accumulation are implemented sequentially, as shown in the timing chart of FIG. 8A. Specifically, a short-term accumulation is started at the timing t12, and terminated at the timing t13. During 2 seconds from the timing t12 to the timing t13, read-out of the accumulated signal charges is conducted (Step S23). Upon supply of a charge sweep pulse VOFD to the overflow drain terminal 3051, the charge accumulation is temporarily suspended. Thereafter, a long-term accumulation is started at the timing t14 for 8 seconds until the timing t15. The on/off control of the charge accumulation is implemented based on a drive timing pulse supplied from the timing generator 502 for driving the image sensor 303.

In Step S27, signal charges are read out from the area including the effective pixel area 3033 of the imaging area 3031, and the upper optical black area 3032D corresponding to the uppermost 1st to 3rd rows of pixels. As shown in the timing chart of FIG. 8A, signal charge read-out operation is implemented during a “measurement read-out mode”, which is an interrupt mode within the ordinary read-out mode, such as the 8-times-speed read-out mode. Specifically, read-out-related information, such as address information, requesting read-out of signal charges exclusively in the measurement read-out mode may be attached to signals outputted from the 1st to 3rd rows of pixels in the upper optical black area 3032D. With such an arrangement, signal charges in the area including the upper optical black area 3032D are read out in the measurement read-out mode.

In this way, signal charges in the short-term accumulation and the long-term accumulation are read out. FIGS. 10B and 10C are graphs respectively showing examples of analog image signals corresponding to the signals read out from the 1st to 3rd rows of pixels in the short-term accumulation and the long-term accumulation. The analog image signals in FIG; 10B and 10C have been subjected to the level correction in the AGC circuit 507 of the analog signal processing section 505. Whereas the signals are outputted substantially at the same level, i.e., flat level, during the short-term accumulation as shown in FIG. 10B, signals containing random noise signals are outputted during the long-term accumulation, as shown in FIG. 10C.

Image data containing the noise signals are outputted to the dark current calculating unit 512 of the camera controlling section 500 in measurement of a dark current value (Step S25). Specifically, dark current values in the short-term accumulation and the long-term accumulation are obtained by providing the clamping area 3032C in the effective pixel area 3033 without providing a clamping area in the upper optical black area 3032D and by using the data in the clamping area 3032C. In the clamping area 3032C, data is reset each time signal charges are read by way of the read-out gate units 303G.

In case of performing the short-term accumulation and the long-term accumulation, a dark current value may be obtained by comparing the short-term accumulation and the long-term accumulation, e.g., by calculating a difference in output in the short-term accumulation and the long-term accumulation and by offsetting an unnecessary noise component, in place of the method of obtaining a dark current value by comparing with the output from the clamping area 3032C, as proposed in the foregoing embodiment. In the output examples shown in FIGS. 10B and 10C, a noise signal is generated merely during the long-term accumulation. Therefore, it is conceived that all the noise components result from the dark current.

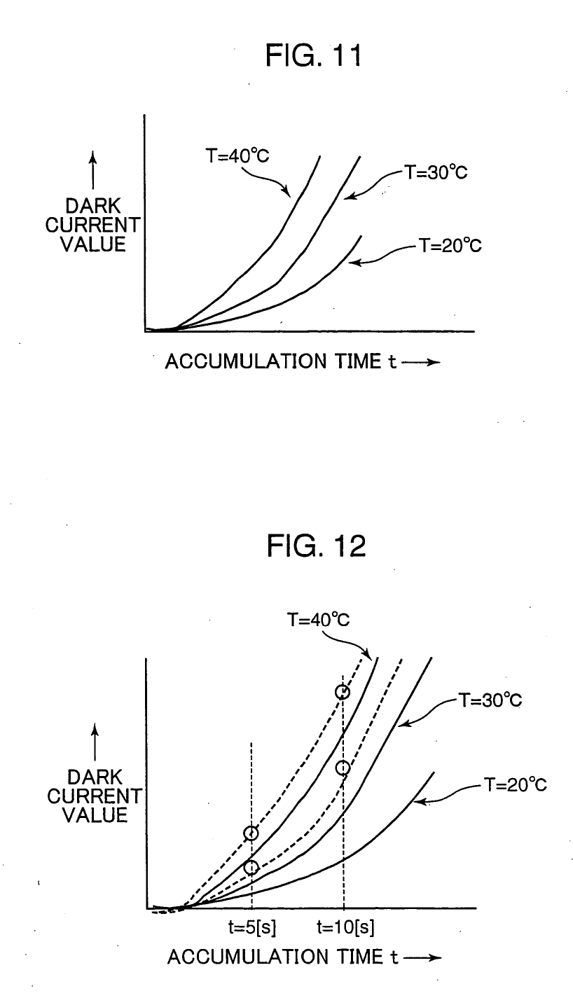

Dark current data calculated by the dark current calculating unit 512 is inputted to the image sensor temperature calculator 5131 of the calculating unit 513. The image sensor temperature calculator 5131 obtains an estimative value of the internal temperature of the image sensor 303 by comparing the temperature lookup table stored in the temperature lookup table storage 514 and the inputted dark current data (Step S27). Specifically, the image sensor temperature calculator 5131 obtains an estimative value of the internal temperature of the image sensor 303 by finding a dark current value in the temperature lookup table corresponding to the calculated dark current data and by retrieving a temperature of the image sensor 303 in correlation with the dark current value in the temperature lookup table (Step S27). As shown in FIG. 11, for example, the temperature lookup table storage 514 stores the temperature lookup table showing a relation between the charge accumulation time of the image sensor 303 and a dark current value at various temperatures, e.g., 20° C., 30° C. and 40° C. With such an arrangement, once a dark current value is determined, the temperature of the image sensor 303 in correspondence to the dark current value is detectable. Namely, the estimative value of the internal temperature of the image sensor 303 at the moment of generation of the dark current is obtained by applying the dark current data to the temperature lookup table.

FIG. 12 is a graph showing an example of applying dark current data to the lookup table. It is possible to estimate the internal temperature of the image sensor 303 based on single dark current data obtained in a single charge accumulation time. It is, however, preferable to use multi dark current data detected in different charge accumulation times to estimate the internal temperature of the image sensor 303. In FIG. 12, dark current data at two different points respectively detected by implementing a short-term accumulation and a long-term accumulation, periods of which are 5 seconds and 10 seconds in the respective accumulations in the example shown in FIG. 12, are plotted out to determine the internal temperature of the image sensor 303. Plotting out data with use of multiple dark current values in correlation to the different charge accumulation times is advantageous in precisely estimating the internal temperature of the image sensor 303.

After estimating the internal temperature of the image sensor 303, the obtained temperature data is outputted to the alteration signal generator 5132. The alteration signal generator 5132 judges whether it is necessary to alter various image processing signals in the digital image processing section 600 in light of the temperature data (Step S29). If the judgment result is negative (NO in Step S29), the routine returns to Step S13 to implement ordinary image processing. If the judgment result is affirmative (YES in Step S29), the routine goes back to Step S13 after generating a required alteration signal (step S31). An example of generating the alteration signal will be described later in detail.

In the foregoing embodiment, it is possible to start a short-term accumulation and a long-term accumulation simultaneously, as shown in FIG. 8B, in place of the arrangement of implementing a short-term accumulation and a long-term accumulation sequentially, as shown in the timing chart of FIG. 8A. Specifically, in FIG. 8B, a short-term accumulation and a long-term accumulation are started simultaneously at the timing t22 of designating the adaptive photographing mode after the timing t21 of initiating the live-viewable mode. After the short-term accumulation is terminated at the timing t23, namely, 2 seconds after the timing t22, signal charges are read out during the measurement read-out mode, whereas after the long-term accumulation is terminated at the timing t25, namely, 8 seconds after the timing t22, signal charges are read out during another measurement read-out mode. Such an altered read-out method is advantageous in shortening the time required for dark current measurement, compared with the arrangement of implementing the short-term accumulation and the long-term accumulation sequentially.

A proposed read-out method for executing the timing chart shown in FIG. 8B is such that the short-term accumulation is followed by reading out signal charges in the 1st row of pixels in the upper optical black area 3032D in FIG. 7, and the long-term accumulation is followed by reading out signal charges from the 2nd to 3rd rows of pixels in the upper optical black area 3032D. In executing the proposed read-out method, controlling the camera so as to prohibit the charge sweep operation during an intermediate time, e.g., around the timing t24, of a dark current measurement period (FIG. 8B) is effective in keeping the long-term accumulation operation from being affected by the charge sweep operation.

In the foregoing embodiment, dark current measurement is conducted during the live-viewable state or live-view mode. The present invention is not limited to the above, and dark current measurement is executable during a mode other than the live-view mode. Implementing the dark current measurement while the digital camera 1 is in the live-view mode, as shown in the first embodiment is preferred because dark current measurement can be automatically conducted, and image processing can be automatically altered in such a manner as to be suitable for the measured dark current value by merely turning on the main switch 105 of the camera 1 to thereby set the camera 1 to the live-viewable state.

(Second Embodiment)

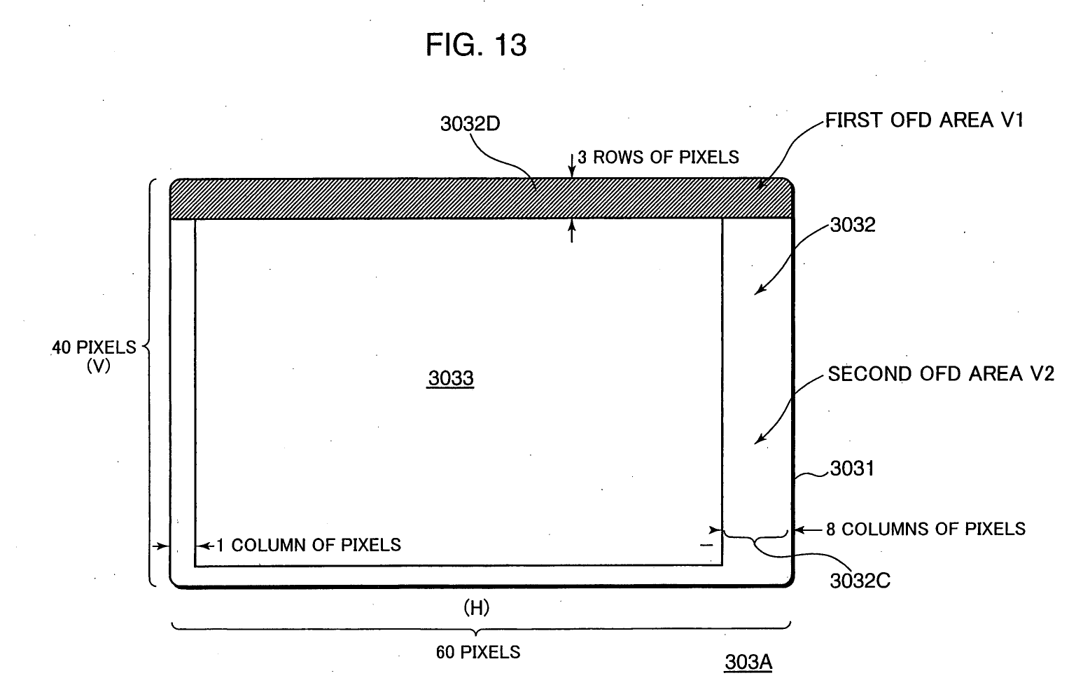

In the first embodiment, an example of using an ordinary CCD sensor as the image sensor 303 has been described. In the second embodiment, an example of using a CCD sensor having specific specifications for implementing the present invention (hereinafter, called as “image sensor 303A”) is described. The image sensor 303A is similar to the image sensor 303 in the basic construction, and, accordingly, description on the elements of the image sensor 303A identical to or similar to those of the image sensor 303 will be omitted herein. Specifically, the image sensor 303A is similar to the image sensor 303 in the basic construction except that, as shown in FIG. 13, the image sensor 303A has an imaging area 3031 which is divided into two sections, namely, a first overflow drain area V1 (hereinafter, called as the “first ODF area V1”) and a second overflow drain area V2 (hereinafter, called as the “ODF area V2”), so that a charge sweep pulses (VOFD) are suppliable to the first ODF area V1 and the second ODF area V2, independently of each other.

More specifically, the first ODF area V1 is constituted of the uppermost 3 rows of pixels, namely, from the 1st to 3rd rows of pixels in an imaging area 3031. The first ODF area V1 corresponds to an upper optical black area 3032D. The ODF area V2 is constituted of the 4-th to 40-th rows of pixels in the imaging area 3031 which corresponds to an effective pixel area 3033 and a clamping area 3032C thereof. The image sensor 303A is constructed by providing an overflow drain terminal 3051 (FIG. 5) individually for the first ODF area V1 and the second ODF area V2, namely, the overflow drain circuits are isolated between the first and second ODF areas V1 and V2, so that a timing generator 502 supplies the charge sweep pulses (VOFD) to the respective overflow drain terminals 3051 individually so as to control a timing of sweeping out the accumulated charges in the first and second ODF areas V1 and V2 independently of each other.

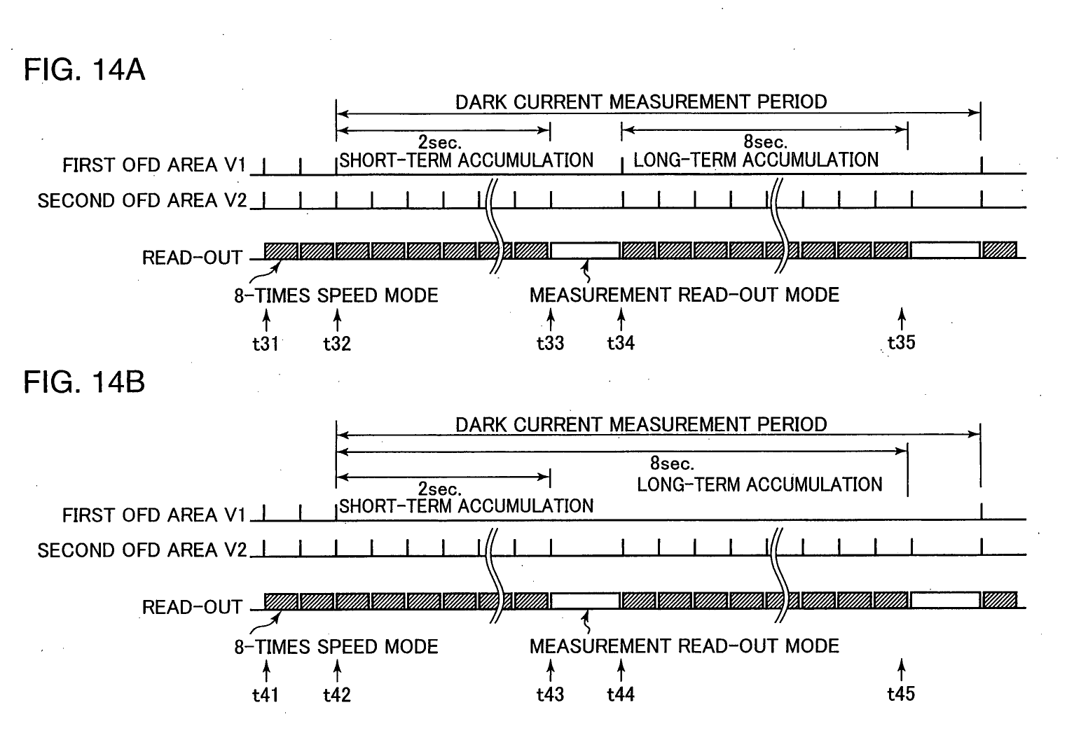

Operations of the image sensor 303A will be described referring to a timing chart shown in FIG. 14A. First, after the timing t31 of initiating the live-view mode, charge sweep pulses (hereinafter, referred to as first VOFD and second VOFD) are outputted to the respective overflow drain terminals 3051 in the first and second ODF areas V1 and V2 at a predetermined timing. During this period, it is possible to or not to supply the charge sweep pulse to the first ODF area V1 at a different timing from the second ODF area V2.

Subsequently, if the adaptive photographing mode is designated after the timing t32, supply of the charge sweep pulse, i.e., first VOFD, from the corresponding overflow drain terminal 3051 to the first ODF area V1 is suspended, while supply of a charge sweep pulse, i.e., second VOFD, from the corresponding overflow drain terminal 3051 to the second ODF area V2 is continued at a predetermined timing. With this arrangement, since a charge sweep operation in the second ODF area V2 corresponding to the effective pixel area 3033 and the clamping area 3032C is continued as normal, the dark current measurement does not substantially affect on display of a live-view image.

Specifically, in this embodiment, in a step corresponding to Step S19 of the flowchart in FIG. 9, supply of a charge sweep pulse (VOFD) is suspended exclusively in the first ODF area V1 which does not substantially affect display of a live-view image. Since supply of a charge sweep pulse (VOFD) in the second ODF area V2 including the effective pixel area is continued as normal even during the measurement of a dark current value, signal charge sweep operation in the effective pixel area can be conducted without influence of the dark current measurement. This arrangement provides smooth control of the electronic shutter of the camera 1, and suppresses blooming or a like drawback.

From the timing t32, a first signal charge accumulation, i.e., short-term accumulation, for measuring a dark current in sensing elements 303S within the first ODF area V1 of the image sensor 303A is initiated. Thereafter, the short-term accumulation is terminated at the timing t33. Signal charges accumulated during the first signal charge accumulation are read out during the measurement read-out period while the camera is set to the measurement read-out mode. Thereafter, the charge sweep pulse, i.e. first VOFD, is supplied to the overflow drain terminal 3051 for the first ODF area V1 at the timing t34 to reset the charge accumulation in the first ODF area V1. Then, a long-term accumulation, the period of which is 8 seconds, is started at the timing t34, and continued until the timing t35. Thereafter, the dark current value is measured in the similar manner as the first embodiment, and the estimative value of the internal temperature of the image sensor 303A is calculated based on the detected dark current value.

As shown in the timing chart in FIG. 14B, alternatively, the short-term accumulation and the long-term accumulation may be initiated simultaneously. Specifically, in the altered arrangement, after the timing t41 of initiating the live-view mode, at the timing t42 of designating the adaptive photographing mode, the short-term accumulation and the long-term accumulation are initiated simultaneously in the sensing elements 303S corresponding to the first ODF area V1. The short-term accumulation is terminated at the timing t43, namely, 2 seconds after the timing t42, and then, signal charges in the 1st row of pixels in the first ODF area V1 are read out during the measurement read-out mode. The long-term accumulation is terminated at the timing t45, namely, 8 seconds after the timing t42, and then, signal charges from the 2nd to 3rd rows of pixels in the first ODF area V1 are read out during another measurement read-out mode. Such an altered read-out method is advantageous in shortening the time required for the dark current measurement, compared with the case of conducting a short-term accumulation and a long-term accumulation sequentially.

With use of the image sensor 303A in which the imaging area 3031 is divided into two sections, namely, the first ODF-area V1 and the second ODF area V2, and the charge sweep pulse (VOFD) is suppliable to the respective first and second ODF areas V1 and V2, individually, a charge sweep timing can be partially differentiated from each other in the first and second ODF areas V1 and V2. This arrangement is applicable to various controlling or sensing operations, and is also useful in the fields other than the dark current detection. For instance, dividing an imaging area into a first section only including the optical black area and a second section including the effective pixel area is effective in allowing the camera to perform an overflow drain in the effective pixel area, i.e., second section, to thereby suppress generation of blooming while allowing the camera to perform various controlling or sensing operations based on image data obtained from the first section.

(Utilization of Detected Image Sensor Temperature)

Various alteration processing, i.e., correction of image processing signals, can be performed with use of the internal temperature of the image sensor 303 (or 303A) detected by the aforementioned method. Hereinafter, the image sensor 303 in the first embodiment and the image sensor 303A in the second embodiment are simply called as the image sensor 303 for the sake of easy explanation. Controlling an exposed state such as altering an exposure time to optimally utilize the operative state of the image sensor 303 by, for example, an exposure controlling unit 516 (FIG. 3) of the camera controlling section 500, based on the estimated temperature data of the image sensor 303 or the detected dark current value is advantageous in forming images of a desired quality.

(Use Example 1: Gain Setting in AFE)

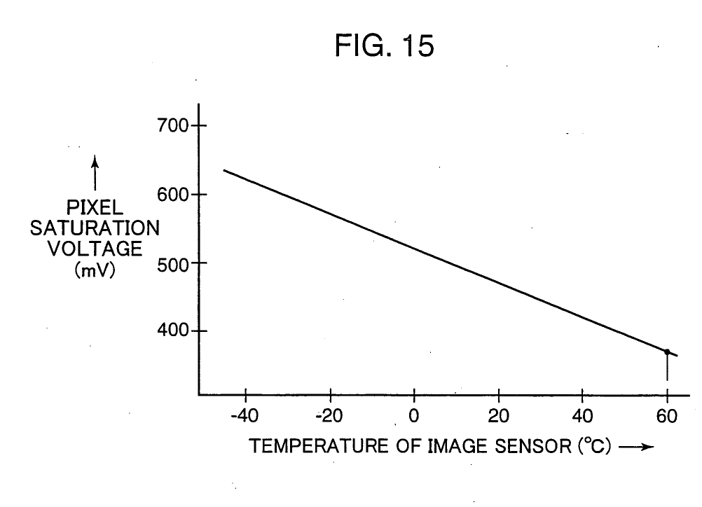

A phenomenon is known that a maximal allowable accumulative quantity of signal charges, i.e., pixel saturation voltage, hereinafter, called as “saturation voltage,” in each sensing element 303S of the image sensor 303 decreases as the temperature of the image sensor 303 rises. FIG. 15 is a graph showing an example of a relation between a temperature of an image sensor and a saturation voltage. As shown in FIG. 15, the saturation voltage is lowered linearly as the temperature of the image sensor rises. In the example of FIG. 15, whereas the saturation voltage is about 500 mV when the temperature of the image sensor is 10° C., the saturation voltage is lowered to about 370 mV when the temperature of the image sensor is 60° C.

Let it be assumed that an analog signal outputted from an image sensor to an A/D converter circuit is converted to a digital signal ranging from 0 to 1023 gradations based on a scale that the gradation is changed by one per 1 mV. In such a case, it is necessary to amplify the saturation voltage lowered to 370 mV to 1023 mV, for example, if the temperature of the image sensor is 60° C. Specifically, referring to the block diagram of FIG. 3, if the temperature of the image sensor is 60° C., prior to digital conversion (AFE) in the A/D converter circuit 508 of the analog signal processing section 505, the analog signal is amplified in the AGC circuit 507 at an amplification ratio, i.e., gain setting value,=1023 mV/370 mV=about 2.76. On the other hand, if the temperature of the image sensor is 10° C., and the saturation voltage is 500 mV, the gain setting value is 1023 mV/500 mV=about 2.05. When the gain is altered, an exposure parameter is also altered.

In this way, altering a gain setting value depending on the temperature of the image sensor is effective in accurately determining the brightness of an object image in terms of a digital signal after A/D conversion. However, if a detection result of the image sensor contains a detection error, it is likely that a noise component may be increased. In other words, an excessively large gain setting value may amplify a noise component, thereby lowering S/N ratio, which is a ratio of an image signal to a noise component. Further, there is proposed a measure of setting a gain setting value at a relatively high value, considering a temperature rise of the image sensor, in case that the internal temperature of the image sensor cannot be precisely detected. However, such a measure reduces a dynamic range of the image sensor.

According to the embodiments of the present invention, since the internal temperature of the image sensor can be determined by the aforementioned dark current measuring method, a gain setting control with use of the temperature data can be implemented as mentioned above. In other words, a saturation voltage can be calculated back based on a detected temperature of the image sensor, and gain setting control can be implemented based on an acquired saturation voltage.

More specifically, a saturation voltage lookup table showing a relation between a temperature of the image sensor and a saturation voltage, as shown in FIG. 15 is stored in the temperature lookup table storage 514 (FIG. 4) as well as the temperature lookup table shown in FIG. 11. First, the image sensor temperature calculator 5131 obtains a temperature of the image sensor 303 by comparing the temperature lookup table stored in the temperature lookup table storage 514 and the dark current value calculated by the dark current calculating unit 512. Next, the image sensor temperature calculator 5131 obtains a current saturation voltage by comparing the saturation voltage table and the obtained temperature of the image sensor 303. Data indicative of the obtained saturation voltage is outputted to the alteration signal generator 5132. The alteration signal generator 5132 generates a signal indicative of a required gain setting value corresponding to the saturation voltage for feeding back the signal to the AGC circuit 507 of the analog signal processing section 505.

In the above arrangement, the gain setting value for amplifying an analog signal immediately before A/D conversion in the A/D converter circuit 508 can be automatically adjusted depending on the temperature of the image sensor 303, thereby obtaining an image of a desired quality with less noise component. Further, this arrangement is advantageous in simplifying the arrangement of the digital camera because there is no need of providing a temperature sensor for detecting the temperature of the image sensor 303 or additionally providing detecting means for detecting a saturation voltage.

In recent years, widely used are digital cameras employing a bias voltage variable system of raising a saturation voltage by varying a bias voltage Vsub to be applied to the semiconductor substrate 3030 in photographing a still image. According to the system, the saturation voltage is lowered by raising the bias voltage Vsub to prevent charges from flowing out to the vertical transmission unit and to thereby suppress blooming while the camera is set to a live-viewable state, and the saturation voltage is raised by lowering the bias voltage Vsub to accumulate charges as much as possible during a photographing operation. Applying the present invention to the digital camera employing the bias voltage variable system is advantageous because the saturation voltage can be substantially precisely determined based on the measured temperature of the image sensor 303.

(Use Example 2: Noise Reduction)

As mentioned above, in the image sensor such as a CCD sensor, a dark current is generated, and such a dark current is superposed over image data, as a dark noise. Random noises generated on the respective devices of the camera and fixed pattern noises that may be fixedly generated on pixels of the CCD sensor are also some of the examples of the dark noise. There is known a noise reduction method of removing dark noises, as disclosed in D1, for example, in which dark exposure data, i.e., dark noise data is acquired by closing the shutter for a time substantially equal to an exposure time to block the image sensor from light, and the dark noise data is subtracted from exposure data acquired by opening the shutter.

A dark noise resulting from a dark current, as mentioned above, increases as the temperature of an image sensor rises, as well as a case where an exposure time is extended. Specifically, as shown in the graph in FIG. 11, a dark current value at the temperature T=40° C. of an image sensor sharply rises, compared with a dark current value at the temperature T=20° C. of the image sensor at the same charge accumulation time.

In view of the above, as described in the foregoing embodiments, a dark noise level can be estimated by detecting the temperature of the image sensor 303. According to the embodiments of the present invention, without closing the shutter after completion of image sensing operation to obtain dark current data, an estimative value of dark noise data can be derived from the temperature of the image sensor 303, and noise reduction can be implemented by subtracting the estimative dark noise data from exposure data obtained from the image sensor.

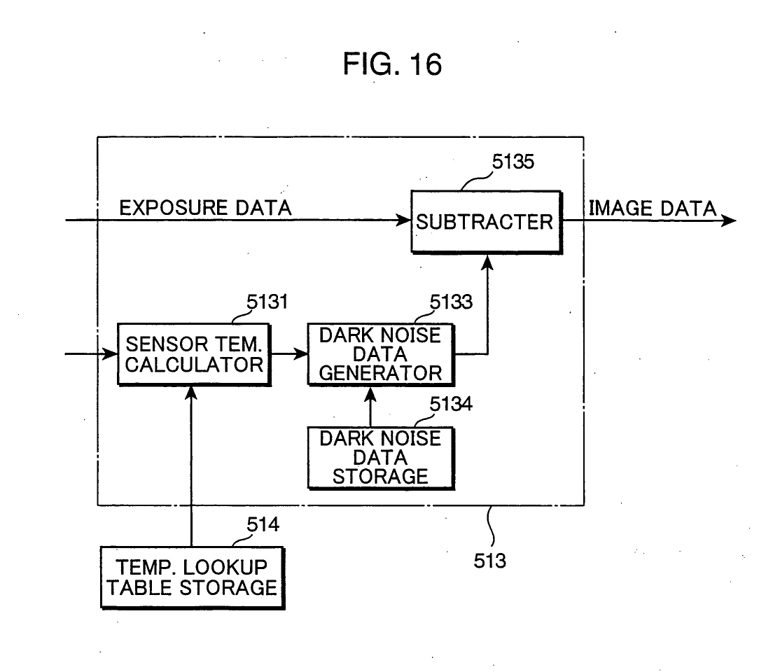

FIG. 16 is a functional block diagram for explaining an exemplified operation of the above noise reduction. FIG. 16 functionally shows relevant elements in conducting the operation of Use Example 2 in the calculating unit 513 shown in FIG. 4. First, the image sensor temperature calculator 5131 obtains a temperature of the image sensor 303 by comparing the temperature lookup table stored in the temperature lookup table storage 514 and the dark current value in the optical black area 3032D calculated by the dark current calculating unit 512. The temperature data is transmitted from the image sensor temperature calculator 5131 to the dark noise data generator 5133. The dark noise data generator 5133 obtains dark noise data at the temperature of the image sensor 303 by finding data corresponding to the transmitted temperature data in a dark noise data lookup table stored in a dark noise data storage 5134, wherein the dark current data lookup table shows a relation between a temperature of the image sensor 303 and dark current data. The configuration of the image sensor temperature calculator 5131 and the dark noise data generator 5133 is not specifically limited, inasmuch as necessary dark noise data is obtainable based on a detected dark current value. The arrangement of the functional block diagram of FIG. 16 may be optionally altered according to needs.

The dark noise data is outputted from the dark noise data generator 5133 to the subtracter 5135. The subtracter 5135 subtracts the dark noise data from exposure data obtained from the image sensor 303. The subtracting processing corresponds to noise reduction of removing dark noises. Thus, image data reduced in noises is generated.

(Use Example 3: Gamma Correction and Offset Adjustment)

Generally, in the digital cameras, the amounts of brightness signals with respect to the entirety of an object image are obtained based on image signals obtained during a live-view mode, and an aperture value and a shutter speed for photographing are set in such a manner as to optimize the brightness signal amounts, i.e., a desirable exposure amount is determined. However, in case that an excessively intensive light beyond a maximal allowable light amount for the image sensor is incident, image signals may be saturated, thereby making it difficult to determine whether the detected brightness signal amount is appropriate. Further, if intensive light such as a ray from the sun is incident as part of an image, it is likely that a flare may be generated, and the brightness in a dark image part may be undesirably raised, which may adversely affect image formation.

Accordingly, it is advantageous to presumptively identify intensive light that may be contained in an object image on the basis of photographing conditions or a histogram regarding the brightness of the object image and to perform gamma correction or offset adjustment so as to alleviate an influence resulting from a flare. In the foregoing embodiments, the gamma correction circuit 604 shown in FIG. 3 implements such an image processing. It is necessary to precisely determine a maximal light amount in order to optimally implement the image processing.

In view of the above, it is required to provide light amount detecting means to determine a maximal allowable light amount. For instance, one of preferred techniques is a technique based on frame image reading for light amount detection. According to this technique, means for detecting a light amount of an object image including a high brightness area is provided to read out image data corresponding to a frame image at such an ultra high speed, e.g., about 1/500 sec., that prohibits saturation of an image signal due to incidence of intensive light. The additional frame is called a light amount detection frame. According to the embodiments of the present invention, as mentioned above, a saturation voltage at a current operative state of the image sensor can be obtained based on the temperature of the image sensor, and therefore, a maximal allowable light amount can be precisely determined based on the saturation voltage, taking into account the temperature factor. This arrangement is advantageous in optimally performing gamma correction and offset adjustment even in use of the frame image reading technique for light amount detection, because the maximal allowable light amount can be more precisely detected.

More specifically, referring to the functional block diagram shown in FIG. 4, similarly to the arrangement of Use Example 1, first, the image sensor temperature calculator 5131 obtains a temperature of the image sensor 303 by comparing the dark current value calculated by the dark current calculating unit 512 and the temperature lookup table stored in the temperature lookup table storage 514. The image sensor temperature calculator 5131 further obtains the current saturation voltage by comparing the obtained temperature of the image sensor 303 and the saturation voltage table. Data indicative of the saturation voltage is inputted to the alteration signal generator 5132. The alteration signal generator 5132 obtains a maximal allowable light amount in the current status based on the inputted saturation voltage data, and generates a signal indicative of an optimal shutter speed and an aperture value for the light amount detection frame, taking into account the maximal allowable light amount. The configuration of the image sensor temperature calculator 5131 or a like element is not specifically limited, inasmuch as necessary dark noise data can be obtained based on a detected dark current value. The functional block diagram shown in FIG. 4 can be optionally altered according to needs.

Alternatively, a maximal allowable light amount may be directly calculated based on a saturation voltage to perform gamma correction and offset adjustment based on the calculated maximal allowable light amount, in place of using the above frame image reading technique for light amount detection, because the saturation voltage at a current operative state of the image sensor can be obtained based on the temperature of the image sensor in the foregoing embodiments.

Some of the preferred embodiments of the present invention have been described in the above. Addition to and/or alteration of the various arrangements described in the embodiments are applicable as far as such addition and/or alteration do not depart from the scope of the present invention. For instance, it is possible to incorporate a program in the camera specifying a timing of dark current measurement and image processing alteration in such a manner that a dark current is cyclically measured at a small time interval immediately after turning on of the main switch of the camera and that the time interval is gradually widened as time lapses from the supply of the power. Incorporating the program in the camera is advantageous in that an optimal image processing alteration depending on a temperature change can be implemented immediately after turning on of the main switch because the temperature change in the image sensor is large immediately after the start of power supply, and that image formation of good quality can be secured even during such a severe temperature change period. It should be noted that as far as parameters in correlation to a temperature are obtainable, a device for detecting a temperature of the image sensor other than the one for obtaining a numeric value, e.g., degrees of C or degrees of F, representing the temperature of the image sensor is embraced in the present invention.

In the foregoing embodiments, the digital camera has been described as an example of the image sensing apparatus of the present invention. Alternatively, the present invention is applicable to video cameras incorporated with various image sensors such as a CCD sensor and a CMOS sensor, as well as to an image sensing device.

According to the embodiments of the present invention, a dark current generated in the image sensor is detected, and the internal temperature of the image sensor is estimated based on the detected dark current value. Whereas in the conventional arrangement, detection of the temperature of the image sensor was limited by the temperature sensor or the like disposed in the vicinity of an image sensor, in this arrangement, the temperature of the image sensor can be derived from the dark current value that securely reflects internal information, i.e., internal temperature data inherent to the image sensor. Accordingly, the internal temperature of the image sensor can be precisely detected. Since an image processing can be altered based on the precisely detected temperature data, an optimal image processing in accordance with a current temperature of the image sensor is executable. Thereby, a digital camera incorporated with the inventive arrangement secures image formation of good quality.

According to the embodiments of the present invention, a dark current value of the image sensor is obtained based on electrical signals read out from the optical black area of the image sensor, and an image processing is altered based on the obtained dark current value. Similar to the above arrangement, this arrangement is advantageous in performing an optimal image processing based on the internal information inherent to the image sensor, thereby securing image formation of good quality. Further, altering an image processing by obtaining the temperature of the image sensor based on the dark current value is advantageous in performing image processing, such as noise reduction, depending on the temperature of the image sensor without closing a mechanical shutter of a camera.

According to the embodiments of the present invention, the dark current measurement is conducted during a live-viewable state of the image sensor. In this arrangement, the dark current measurement is performed automatically, and image processing is altered automatically in accordance with the detected dark current value once the main switch of the camera is turned on, and the camera is set to a live-viewable state. This arrangement is advantageous in eliminating a photographing suspended state for acquiring dark current data, which has been required in the conventional art, thereby securing usability of a user.

According to the embodiments of the present invention, stored is the temperature lookup table showing a relation between a temperature of the image sensor and a dark current value. In this arrangement, once the dark current value is measured by the dark current measuring unit, the current temperature of the image sensor is immediately estimated by comparing the measured dark current value with the temperature lookup table.

According to the embodiments of the present invention, since measurement of the dark current by the dark current measuring unit is conducted plural number of times by varying the charge accumulation time in the image sensor. This arrangement makes it possible to detect the temperature of the image sensor with high precision. Specifically, the longer the charge accumulation time is, the larger the detected dark current value is. The temperature of the image sensor can be detected more precisely by performing, e.g., a short-term accumulation and a long-term accumulation sequentially or simultaneously, because the number of data to be compared with the temperature lookup table is increased.

According to the embodiments of the present invention, since an arrangement of prohibiting an overflow drain, namely, prohibiting excessive signal charge sweep operation during the dark current measurement is employed, the dark current measurement can be performed in a simplified manner even in use of a known versatile CCD sensor as the image sensor.

According to the embodiments of the present invention, since the charge accumulation time lasts 1 second or longer, the dark current measurement can be implemented effectively in light of the property of a dark current that longer the charge accumulation time is, the larger the dark current value is.

According to the embodiments of the present invention, the image sensor has a vertical overflow drain structure, and is so configured that a charge sweep timing in a part of the optical black area is controllable independently of a charge sweep timing in the effective pixel area other than the part. In this arrangement, for instance, the dark current measurement is conducted with use of the image data obtained from the optical black area, while continuing the overflow drain in the effective pixel area during the dark current measurement period. This arrangement is advantageous in preventing a user from feeling it uncomfortable to know that the camera is in the dark current measurement period because the quality of a live-view image is not deteriorated during a live-view display by suppressing blooming or the like.

According to the embodiments of the present invention, since a saturation voltage lookup table showing a relation between a temperature of the image sensor and a saturation voltage of the image sensor is stored, various image processing can be implemented by converting the temperature data obtained by the dark current measurement to the saturation voltage data. This arrangement provides versatile use of the dark current value.

According to the embodiments of the present invention, since gain setting control, gamma correction, and offset adjustment are performed based on the saturation voltage data, these processing can be performed in an optimal condition depending on the temperature of the image sensor, thereby securing image formation of good quality.

According to the embodiments of the present invention, since dark noise data depending on the temperature of the image sensor is generated, and noise reduction control is performed based on the dark noise data, noise reduction control depending on the temperature of the image sensor can be performed in an optimal condition, thereby securing image formation of good quality.

According to the embodiments of the present invention, since the imaging area of the image sensor is divided into plural sections such that a charge sweep pulse for overflow drain is suppliable to the respective sections independently of each other, the timing of outputting the charge sweep pulse can be partially differentiated from each other in the respective sections, thereby improving usability of the image sensor in various control operations. For instance, dividing the imaging area into a first section corresponding to an optical black area, and a second section including an effective pixel area is advantageous in suppressing blooming in the effective pixel area by allowing the overflow drain to be continued in the effective pixel area or the second section while carrying out various controlling or sensing operations based on the image data outputted from the optical black area or the first section.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

1. An image sensing apparatus comprising:
an image sensor to photoelectrically convert an object image to electrical signals;
a controller to controllably read out the electrical signals generated in the image sensor;
a processor to apply a predetermined image processing to the read-out electrical signals; and
an estimating part to obtain a value of a dark current generated in the image sensor for estimating an internal temperature of the image sensor based on the dark current value,
wherein the image processing by the processor is altered based on the estimative value of the internal temperature of the image sensor outputted from the estimating part.

2. An image sensing apparatus comprising:
an image sensor to photoelectrically convert an object image to electrical signals, the image sensor including an optical black area which is blocked from light;
a controller to controllably read out the electrical signals generated in the image sensor; and
a processor to apply a predetermined image processing to the read-out electrical signals,
wherein the controller is operative to obtain a value of a dark current generated in the image sensor based on the electrical signals read out from the optical black area of the image sensor, and to generate an alteration command signal requesting alteration of the image processing by the processor based on the dark current value.

3. The image sensing apparatus according to claim 2, wherein the controller obtains the dark current value during a live-viewable state of the image sensor.

4. The image sensing apparatus according to claim 2, wherein a temperature lookup table showing a relation between a temperature of the image sensor and a dark current value is stored, and the estimative value of the internal temperature of the image sensor is calculated by comparing the value of the dark current and the stored values in the temperature lookup table to alter the image processing based on the calculated estimative value of the internal temperature of the image sensor.

5. The image sensing apparatus according to claim 2, wherein the controller obtains the dark current value plural number of times by varying a charge accumulation time in the image sensor.

6. The image sensing apparatus according to claim 5, wherein the image sensor is of a vertical overflow drain structure, and is so controlled as to suspend an overflow drain during a period of obtaining the dark current value.

7. The image sensing apparatus according to claim 5, wherein the charge accumulation time in the image sensor lasts for one second or longer.

8. The image sensing apparatus according to claim 5, wherein the image sensor is of a vertical overflow drain structure, and is so configured as to control, independently of each other, a timing of sweeping-out of accumulated charges in a first portion of the image sensor that is a part of the optical black area and a timing of sweeping-out of accumulated charges in a second portion of the image sensor that is other than the first portion and includes an effective pixel area.

9. The image sensing apparatus according to claim 4, wherein a saturation voltage lookup table showing a relation between a temperature of the image sensor and a saturation voltage of the image sensor is stored, and the alteration command signal requesting alteration of the image processing is generated by comparing the calculated estimative value of the internal temperature of the image sensor and the saturation voltage lookup table.

10. The image sensing apparatus according to claim 9, wherein the alteration command signal is adapted to controllably determine, prior to analog-to-digital conversion of an analog signal outputted from the image sensor, a gain setting value for amplifying the analog signal.

11. The image sensing apparatus according to claim 9, wherein the alteration command signal is adapted to perform gamma correction and/or offset adjustment.

12. The image sensing apparatus according to claim 4, further comprising a dark noise data lookup table storing a relation between a temperature of the image sensor and dark noise, wherein dark noise data is generated depending on the internal temperature of the image sensor by comparing the calculated estimative value of the internal temperature of the image sensor and the stored values in the dark noise data lookup table to perform noise reduction on a basis of the generated dark noise data.

13. An image sensor of a vertical overflow drain structure, comprising:
an imaging area which is divided into a plurality of sections; and
at least one overflow drain terminal, the at least one overflow drain terminal being operative to supply a charge sweep pulse for overflow drain in the respective sections independently of each other.

14. The image sensor according to claim 13, wherein the imaging area includes a first section corresponding to an optical black area which is blocked from light, and a second section including an effective pixel area.
